(19) United States
(12) Patent Application Publication
(10) Pub. No.: US 2026/0291369 A1
(43) Pub. Date: Sep. 24, 2026

(54) CONVERTER CIRCUIT WITH POSITIVE AND NEGATIVE OUTPUT VOLTAGES

(71) Applicant: STMicroelectronics International N.V., Geneva (CH)

(72) Inventor: Laurent GONTHIER, Shenzhen (CN)

(21) Appl. No.: 19/086,397

(22) Filed: Mar. 21, 2025

(51) Int. Cl. H02M 1/00; H02M 3/158

(52) U.S. Cl. CPC H02M 1/0083; H02M 3/158

(57) ABSTRACT

An example converter circuit, an electrical system comprising a converter circuit, and a method for generating a positive output voltage and a negative output voltage at a converter circuit are provided. The example converter circuit including a first terminal and a second terminal configured to receive a DC voltage, buck switching circuitry, and freewheeling circuitry. The buck switching circuitry including a buck switching device, an energy storage device, and a positive output capacitor. The freewheeling circuitry including a negative output capacitor, and a freewheeling device. The buck switching device, the energy storage device, the positive output capacitor, the negative output capacitor, and the freewheeling device electrically connected in series. A positive output voltage relative to a common ground terminal is generated across the positive output capacitor, and a negative output voltage relative to the common ground terminal is generated across the negative output capacitor.

### TECHNOLOGICAL FIELD

Embodiments of the present disclosure relate generally to converter circuits, and more particularly, to converter circuits configured to generate both positive and negative output voltages.

### BACKGROUND

A buck converter circuit, also known as a step-down converter, is a type of DC-DC power converter that reduces a higher input voltage to a lower output voltage while maintaining energy efficiency. A buck converter circuit generally utilizes a combination of switching elements (e.g., transistors), energy storage elements (e.g., inductors, capacitors), and diodes, to regulate and smooth the output voltage. Buck converter circuits are critical in modern electronics because many modern electronics comprise a wide variety of electrical devices, each having their own power requirements. Buck converter circuits are essential in applications in which maintaining optimal voltage levels are necessary for performance, reliability, and energy savings. In addition, many electrical systems comprise electrical devices requiring both positive and negative power supplies. The notion of negative tension and an abuse of language. A negative voltage is said when the potential opposite the circuit main reference potential (usually called the ground) is at a negative value compared to this reference.

Applicant has identified many technical challenges and difficulties associated with generating both positive and negative output voltages at a converter circuit. Through applied effort, ingenuity, and innovation, Applicant has solved problems related to generating both positive and negative output voltages at a converter circuit by developing solutions embodied in the present disclosure, which are described in detail below.

### BRIEF SUMMARY

Various embodiments are directed to an example converter circuit, an electrical system comprising a converter circuit, and a method for generating a positive output voltage and a negative output voltage based on a high voltage signal received at a converter circuit.

An example converter circuit is provided. The example converter circuit comprising a first terminal and a second terminal configured to receive a DC voltage, buck switching circuitry, and freewheeling circuitry. The buck switching circuitry comprising a buck switching device, an energy storage device, and a positive output capacitor. The freewheeling circuitry comprising a negative output capacitor, and a freewheeling device. The buck switching device, the energy storage device, the positive output capacitor, the negative output capacitor, and the freewheeling device electrically connected in series. A positive output voltage relative to a common ground terminal is generated across the positive output capacitor, and a negative output voltage relative to the common ground terminal is generated across the negative output capacitor. Wherein the common ground terminal is the second terminal.

In some embodiments, the converter circuit further comprising control circuitry. The control circuitry comprising a negative output regulation switch electrically connected in parallel to the negative output capacitor and the freewheeling device. Wherein the negative output regulation switch regulates the negative output voltage across the negative output capacitor.

In some embodiments, to regulate the negative output voltage across the negative output capacitor, the control circuitry is achieving a Hysteresis control law configured to enable or disable the negative output regulation switch in accordance with the Hysteresis control law.

In some embodiments, to regulate the negative output voltage across the negative output capacitor, the control circuit updates a duty cycle associated with the negative output regulation switch.

In some embodiments, the negative output regulation switch comprises a first p-channel metal-oxide-semiconductor (PMOS). The first PMOS comprising a first PMOS source terminal, first PMOS drain terminal, and a first PMOS gate terminal. The first PMOS source terminal electrically connected to a net point between the positive output capacitor and the negative output capacitor. The first PMOS drain terminal electrically connected to an output terminal of the freewheeling device. The first PMOS gate terminal configured to receive a control signal from the control circuitry.

In some embodiments, the negative output regulation switch comprises a first n-channel metal-oxide-semiconductor (NMOS) comprising a first NMOS source terminal, a first NMOS drain terminal, and a first NMOS gate terminal. The first NMOS source terminal electrically connected to a net point between the buck switching device and the energy storage device. The first NMOS drain terminal electrically connected to the cathode of a second diode. The first NMOS gate terminal configured to receive a control signal from the control circuitry. Wherein an anode terminal of the second diode is electrically connected to the common ground terminal.

In some embodiments, the freewheeling device is a diode.

In some embodiments, the freewheeling device is a second p-channel metal-oxide-semiconductor (PMOS) or a first n-channel metal-oxide-semiconductor (NMOS).

An electrical system is further provided. In some embodiments, the electrical system comprising a converter circuit, a positive circuit portion, and a negative circuit portion. The converter circuit comprising a first terminal and a second terminal configured to receive a DC voltage, buck switching circuitry, and freewheeling circuitry. The buck switching circuitry comprising a buck switching device, an energy storage device, and a positive output capacitor. The freewheeling circuitry comprising a negative output capacitor, and a freewheeling device. Wherein the buck switching device, the energy storage device, the positive output capacitor, the negative output capacitor, and the freewheeling device are electrically connected in series. Wherein a positive output voltage relative to a common ground terminal is generated across the positive output capacitor. Wherein a negative output voltage relative to the common ground terminal is generated across the negative output capacitor. Wherein the common ground terminal is the second terminal. The positive circuit portion supplied with positive voltage configured to receive the positive output voltage from the converter circuit. The negative circuit portion supplied with negative voltage configured to receive the negative output voltage from the converter circuit.

In some embodiments, the converter circuit further comprises control circuitry. The control circuitry comprising a negative output regulation switch electrically connected in parallel to the negative output capacitor and the freewheeling device. Wherein the negative output regulation switch regulates the negative output voltage across the negative output capacitor.

In some embodiments, to regulate the negative output voltage across the negative output capacitor, the control circuitry is achieving a Hysteresis control law configured to enable and disable the negative output regulation switch in accordance with the Hysteresis control law.

In some embodiments, to regulate the negative output voltage across the negative output capacitor, the control circuit updates a duty cycle associated with the negative output regulation switch.

In some embodiments, the negative output regulation switch of the control circuitry comprises a first p-channel metal-oxide-semiconductor (PMOS). The first PMOS comprising a first PMOS source terminal, a first PMOS drain terminal, and a first PMOS gate terminal. The first PMOS source terminal electrically connected to a net point between the positive output capacitor and the negative output capacitor. The first PMOS drain terminal electrically connected to an output terminal of the freewheeling device. The first PMOS gate terminal configured to receive a control signal from the control circuitry.

In some embodiments, the negative output regulation switch comprises a first n-channel metal-oxide-semiconductor (NMOS). The first NMOS comprising a first NMOS source terminal, a first NMOS drain terminal, and a first NMOS gate terminal. The first NMOS source terminal electrically connected to a net point between the buck switching device and the energy storage device. The first NMOS drain terminal electrically connected to the cathode of a second diode. The first NMOS gate terminal configured to receive a control signal from the control circuitry. The second diode comprising an anode terminal connected to the common ground terminal.

In some embodiments, the freewheeling device is a diode.

A method for generating a positive output voltage relative to a common ground terminal and a negative output voltage relative to the common ground terminal based on a high voltage signal at a converter circuit is further provided. In some embodiments, the method comprising providing the converter circuit. The converter circuit comprising a first terminal, a second terminal, buck switching circuitry, and freewheeling circuitry. The first terminal and the second terminal configured to receive a DC voltage, wherein the common ground terminal is the second terminal. The buck switching circuitry comprising a buck switching device, an energy storage device, and a positive output capacitor. The freewheeling circuitry comprising a negative output capacitor, and a freewheeling device. Wherein the buck switching device, the energy storage device, the positive output capacitor, the negative output capacitor, and the freewheeling device are electrically connected in series. The method further comprising receiving at the buck switching device of the converter circuit, the high voltage signal comprising a high voltage amplitude; periodically closing the buck switching device, based on the positive output voltage; generating the positive output voltage across the positive output capacitor; and generating the negative output voltage across the negative output capacitor.

In some embodiments, the method further comprises regulating, by a control circuitry, the negative output voltage across the negative output capacitor, wherein the control circuitry comprises a negative output regulation switch electrically connected in parallel to the negative output capacitor.

In some embodiments, regulating the negative output voltage across the negative output capacitor further comprises: generating, at a hysteresis comparator, a control signal based on a comparison of the negative output voltage to a negative output voltage reference; and enabling the negative output regulation switch to regulate the negative output voltage.

In some embodiments, the negative output regulation switch comprises a first p-channel metal-oxide-semiconductor (PMOS). The first PMOS comprising a first PMOS source terminal, a first PMOS drain terminal, and a first PMOS gate terminal. The first PMOS source terminal electrically connected to a net point between the positive output capacitor and the negative output capacitor. The first PMOS drain terminal electrically connected to an output terminal of the freewheeling device. The first PMOS gate terminal configured to receive the control signal from the hysteresis comparator.

In some embodiments, the negative output regulation switch comprises a first n-channel metal-oxide-semiconductor (NMOS). The first NMOS comprising a first NMOS source terminal, a first NMOS drain terminal, and a first NMOS gate terminal. The first NMOS source terminal electrically connected to a net point between the buck switching device and the energy storage device. The first NMOS drain terminal electrically connected to the cathode of a second diode. The first NMOS gate terminal configured to receive a control signal from the control circuitry. Wherein an anode terminal of the second diode is electrically connected to the common ground terminal.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example converter circuit in accordance with an example embodiment of the present disclosure.

FIG. 2 illustrates an example schematic diagram of an example converter circuit in accordance with an example embodiment of the present disclosure.

FIG. 3 depicts current flow during a closed switch state in an example converter circuit in accordance with an example embodiment of the present disclosure.

FIG. 4 depicts current flow during a freewheeling state in an example converter circuit in accordance with an example embodiment of the present disclosure.

FIG. 5 depicts current flow during a freewheeling state regulated by a negative output regulation switch in accordance with an example embodiment of the present disclosure.

FIG. 6 illustrates an example schematic diagram of example control circuitry in accordance with an example embodiment of the present disclosure.

FIG. 7 depicts an example electrical system comprising a converter circuit in accordance with an example embodiment of the present disclosure.

FIG. 8 depicts an example signal diagram for an example converter circuit in accordance with an example embodiment of the present disclosure.

FIG. 9 illustrates an example schematic diagram of an example converter circuit in accordance with an example embodiment of the present disclosure.

FIG. 10 depicts an example process for generating a positive output voltage and a negative output voltage based on a high voltage signal received at a converter circuit in accordance with an example embodiment of the present disclosure.

### DETAILED DESCRIPTION

Example embodiments will be described more fully hereinafter with reference to the accompanying drawings, in which some, but not all embodiments of the inventions of the disclosure are shown. Indeed, embodiments of the disclosure may be embodied in many different forms and should not be construed as limited to the embodiments set forth herein; rather, these embodiments are provided so that this disclosure will satisfy applicable legal requirements. Like numbers refer to like elements throughout.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communications circuitry, input/output circuitry, and the like. In some embodiments, other elements may provide or supplement the functionality of particular circuitry.

### Overview

Various example embodiments address technical problems associated with generating positive and negative output voltages at a buck converter circuit. As understood by those of skill in the field to which the present disclosure pertains, there are numerous example scenarios in which an electrical system may benefit from a buck converter configured to generate both a positive and negative output voltage.

For example, a buck converter circuit, also known as a step-down converter, is a type of DC-DC power converter that reduces a higher input voltage to a lower output voltage while maintaining energy efficiency. A buck converter circuit generally utilizes a combination of switching elements (e.g., transistors), energy storage elements (e.g., inductors, capacitors), and diodes, to regulate and smooth the output voltage. Buck converter circuits are critical in modern electronics because many modern electronics comprise a wide variety of electrical devices, each having their own power requirements. Buck converter circuits enable efficient power management, minimizing energy loss during voltage conversion while providing an appropriate power supply to each of the electrical devices. Buck converter circuits are widely used in battery-powered devices and plug-in devices alike. Buck converter circuits are essential in applications in which maintaining optimal voltage levels are necessary for performance, reliability, and energy savings.

While many electrical devices require positive power supplies, some electrical devices require negative power supplies for operation. Such devices may include Silicon Carbide metal-oxide-semiconductor field-effect transistors (MOSFETs), Gallium Nitride MOSFETs, and/or triacs (triodes for alternating current). Buck converter circuits configured to generate positive power supplies and negative power supplies are especially useful in electrical systems requiring both types of power supplies.

Example converters configured to generate both positive and negative power supplies generally include a transformer. The secondary windings of the transformer generate a voltage with a given ration of the voltage at the primary transformer windings which is insulated (or sometimes described as floating) from the primary winding voltage. The high potential of this secondary voltage can then be connected to the ground reference of the circuit to create a negative output. The positive output can then be achieved by another secondary winding or by part of the voltage provided by the 1^{st} secondary winding. Unfortunately, utilizing transformers in switching-mode converters may be prohibitively expensive in many applications. In addition, the transformers are bulky, requiring additional space for implementation. Further, transformers need to be designed and tuned for each case, making a switching-mode converter dependent on a transformer difficult to implement.

The various example embodiments described herein utilize various techniques to generate a positive output voltage and a negative output voltage at a non-insulated converter circuit. For example, the converter circuit may include buck switching circuitry configured to generate a positive output voltage and freewheeling circuitry configured to generate a negative output voltage. The buck switching circuitry and freewheeling circuitry are configured such that a buck switching device, an energy storage device, a positive output capacitor, a negative output capacitor, and a freewheeling device are all electrically connected in series.

The converter circuit is configured to operate in at least two modes. A closed switch mode in which the buck switching device is closed. During the closed switch mode, the energy storage device is charged by a voltage source electrically connected to the buck switching device. In addition, the positive output voltage across the positive output capacitor is generated by the voltage source.

The converter circuit is further configured to operate in a freewheeling mode. During a freewheeling mode, the buck switching device is open, and thus no power is received from the voltage source. Instead, current flows through both the positive output capacitor and the negative output capacitor maintaining the positive output voltage at the positive output capacitor and generating a negative output voltage across the negative output capacitor. Thus, both the positive output voltage across the positive output capacitor and the negative output voltage across the negative output capacitor are generated by the energy storage device during the freewheeling mode.

Further, the converter circuit may include a negative output regulation switch electrically connected in parallel with the negative output capacitor. The negative output regulation switch may be utilized to regulate the negative output voltage. For example, in an instance in which the negative output voltage exceeds a negative output voltage reference, the control circuitry may be configured to close an embedded negative output regulation switch. Closing the negative output regulation switch creates a path for current flow through the negative output regulation switch, stopping the charge of the capacitor of the negative output voltage and preventing the negative output voltage across the negative output capacitor from increasing.

As a result of the example embodiments described herein, the complexity of a converter circuit configured to generate both a positive output voltage and a negative output voltage may be greatly reduced, due at least in part to the elimination of a custom designed and fine-tuned transformer uniquely designed for each case. In addition, the size of a converter circuit configured to generate both a positive output voltage and a negative output voltage may be greatly reduced. Further, eliminating the transformer in a switching-mode converter circuit generating both a positive output voltage and a negative output voltage may greatly reduce the cost of manufacturing of the converter circuit.

### Exemplary Systems and Apparatuses

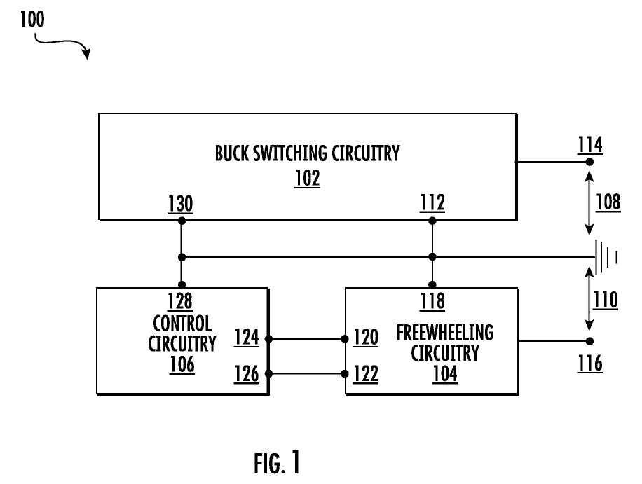

Referring now to FIG. 1, an example converter circuit 100 is provided. As depicted in FIG. 1, the example converter circuit 100 includes buck switching circuitry 102 configured to generate a positive output voltage 108 at terminal 114, with reference to a reference terminal (e.g., ground terminal). The buck switching circuitry 102 comprises a terminal 112 electrically connected to a terminal 118 at freewheeling circuitry 104 and configured to transmit a freewheeling current coming from terminal 112 to the freewheeling circuitry 104. As further depicted in FIG. 1, the example converter circuit 100 includes a control circuitry 106 electrically connected to the freewheeling circuitry 104 and configured to regulate the negative output voltage 110.

As described herein, the example converter circuit 100 is configured to generate a positive output voltage 108 and a negative output voltage 110 based on a high voltage source. Although not depicted in FIG. 1, it is understood that a high voltage source may be within the buck switching circuitry 102 or otherwise connected to the buck switching circuitry 102. In general, the converter circuit 100 is a step-down converter. A step-down converter may be a type of DC-DC power converter that reduces a higher input voltage, for example from the high voltage source to a lower output voltage (e.g., positive output voltage 108 and negative output voltage 110). Thus, the amplitude of the positive output voltage 108 and generally the negative output voltage 110 at the output terminals (e.g., terminal 114 and terminal 116) are both lower than the amplitude of the input voltage. The amplitude of the negative output voltage 110 is set by the control circuitry 106 itself and independently of the input voltage. But in practice an absolute amplitude lower or equal to the input voltage will usually be chosen.

A converter circuit 100 may be utilized within an electrical system to provide accurate and stable supply voltages to various components of an electrical system based on a higher input voltage. Thus, utilizing a converter circuit 100, each electrical component of an electrical system may receive a supply voltage within the specifications of the particular electrical component. Further, electrical systems may comprise some electrical components that require positive supply voltages and some electrical components that require negative supply voltages. For example, common electrical components requiring negative power supplies may include Silicon Carbide MOSFETs, Gallium Nitride MOSFETs, and triodes for alternating current (e.g., triacs). Such electrical components may be common in home appliances, industrial control boards, and other electrical systems.

In some embodiments, a converter circuit 100 may be referred to as a non-insulated converter circuit 100. In general, switching-mode converter using transformers may be referred to as insulated power supplies. However, as described herein, the converter circuit 100 does not utilize a transformer. Thus, the converter circuit 100 may comprise a non-insulated power supply and be referred to as a non-insulated converter circuit 100.

As depicted in FIG. 1, the example converter circuit 100 includes buck switching circuitry 102. The buck switching circuitry 102 may comprise any circuitry including hardware and/or software configured to generate a positive output voltage 108 having a lower amplitude than a source input voltage. Positive output voltages 108 may be transmitted as the supply voltage to various components of an electrical system, for example, power factor correction (PFC) circuits and/or intelligent power module (IPM) circuit.

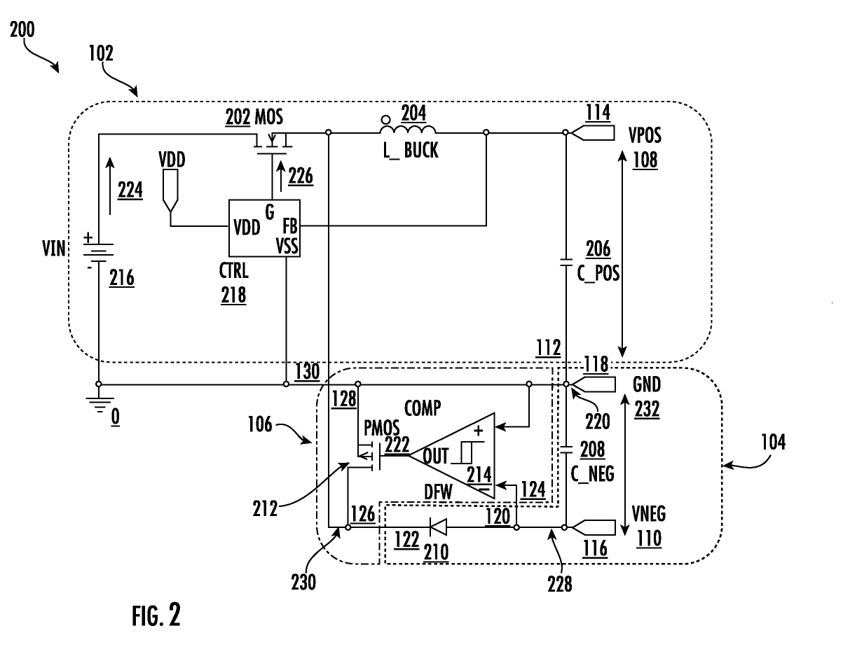

The buck switching circuitry 102 further receives a freewheeling current from an energy storage device (e.g., energy storage device 204 as described in relation to FIG. 2). The freewheeling circuitry 104 is any circuitry configured to receive a freewheeling current received from the energy storage device and generate a negative output voltage 110 based on the freewheeling current. Negative output voltages 110 may be transmitted as the supply voltage to various components of an electrical system, for example, Silicon Carbide MOSFETs, Gallium Nitride MOSFETs, and triodes for alternating current (e.g., triacs) through their driver circuits.

As further depicted in FIG. 1, the example converter circuit 100 comprises control circuitry 106. The control circuitry 106 comprises any circuitry including hardware and/or software configured to regulate the negative output voltage 110 applied between the terminal 116 and the reference terminal. In the following we will call the negative output voltage 110 this potential difference, taking the lowest value point of the negative output voltage 110 as the reference potential in order to get a positive value of this voltage. In other words, in the following all voltage levels and amplitudes will be considered as their absolute values. In some embodiments, the control circuitry 106 could be set to follow different control methods, like for example but not limited to, control by hysteresis or by Pulse-Width Modulation control. The control circuitry 106 includes one or more components to measure the negative output voltage 110 and compare the negative output voltage 110 to a negative output voltage reference (e.g., negative output voltage threshold).

The negative output voltage reference is any amplitude and/or voltage level, wherein which the negative output voltage 110 will be regulated by the control circuitry to be close to the negative output voltage reference. The control circuitry 106 helps to control the maximum amplitude of the negative output voltage 110. The negative output voltage reference may comprise a voltage level or amplitude. A negative output voltage 110 may exceed the negative output voltage reference in an instance in which the negative output voltage 110 drops below the negative output voltage reference. For example, in an instance in which the negative output voltage reference is 10 volts, any negative output voltage 110 above10 volts (e.g., 11 volts) exceeds the negative output voltage reference. In an instance in which the negative output voltage 110 exceeds the negative output voltage reference, the control circuitry 106 may stop the increase of the amplitude of the negative output voltage 110. For example, the control circuitry 106 may close a switch enabling a current path for the freewheeling current which is then no more circulating through the freewheeling circuitry 104, but through the control circuitry 106, and back to the buck switching circuitry 102 with minimal resistance. The control circuitry 106 is further described in relation to FIGS. 2 - 6.

In some embodiments, the control circuitry 106 may act in accordance with a Hysteresis control law. A Hysteresis control law may include any strategy to maintain a negative output voltage 110 at or near the negative output voltage reference.

Referring now to FIG. 2, an example converter circuit 200 is provided. The converter circuit 200 is one example embodiment of the converter circuit 100. It will be appreciated that various embodiments may include more or less circuitries than depicted in FIG. 2. The example converter circuit 200 includes buck switching circuitry 102 electrically connected to freewheeling circuitry 104, and further electrically connected to control circuitry 106 which is here achieving a hysteresis control mode.

As depicted in FIG. 2, the buck switching circuitry 102 comprises a voltage source 216, a controller 218, a buck switching device 202, an energy storage device 204, and a positive output capacitor 206. As further depicted in FIG. 2, the buck switching circuitry 102 is configured to generate a positive output voltage 108 applied across terminal 114 and ground reference 232 (e.g., across the positive output capacitor 206). As described herein, the positive output voltage 108, refers to the potential difference between the terminal 114 and the ground reference 232.

The buck switching circuitry 102 includes a buck switching device 202. A buck switching device 202 comprises any switching component configured to change between a closed state and an open state based on a received switching control signal 226. As described herein, a switching device in a closed state may be interpreted to mean a conductive path through the switching device is defined such that an electrical signal may be transmitted through the switching device. Further, a switching device in an open state may be interpreted to mean a conductive path is broken at the switching device such that an electrical signal may not be transmitted through the switching device.

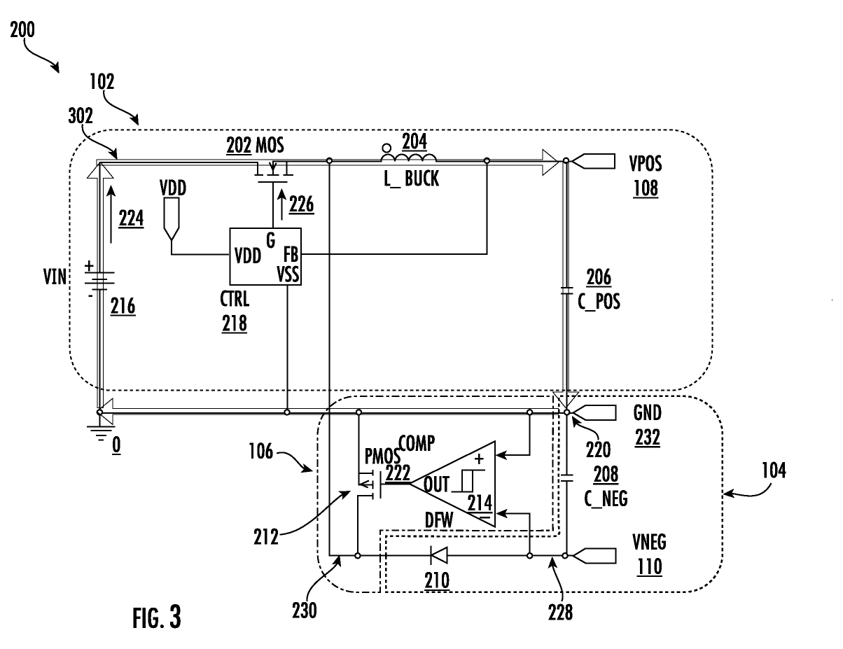

As depicted in FIG. 2, the buck switching device 202 comprises an n-type MOSFET comprising a drain terminal electrically connected to a positive terminal of the voltage source 216, a gate terminal electrically connected to a gate output terminal of the controller 218, and a source terminal electrically connected to a first terminal of the energy storage device 204. The conductive path between the source terminal of the buck switching device 202 and the first terminal of the energy storage device 204 is further electrically connected to net point 230. The buck switching device 202 is configured to receive a high voltage potential 224 from the voltage source 216. In an instance in which the buck switching device 202 is enabled through the switching control signal 226, the converter circuit 200 operates in a closed switch state. During the closed switch state, the high voltage potential 224 is used to charge the energy storage device 204. In addition, the positive output voltage 108 is generated across the positive output capacitor 206 based on the high voltage potential 224. Operation during the closed switch state is further described in relation to FIG. 3.

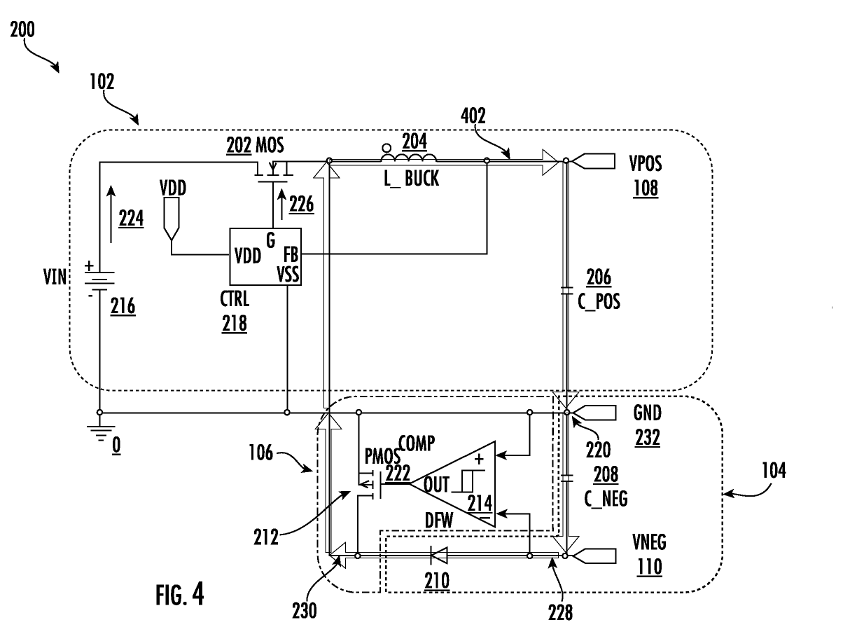

In an instance in which the buck switching device 202 is disabled through the switching control signal 226, the converter circuit 200 operates in an open switch state, also known as a freewheeling state. During the freewheeling state, the buck switching device 202 is open. Thus, the positive output voltage 108 is generated across the positive output capacitor 206 based on the energy stored in the energy storage device 204. In addition, the negative output voltage 110 is generated across the negative output capacitor 208 based on the energy stored in the energy storage device 204 during the freewheeling state. Operation during the freewheeling state is further described in relation to FIGS. 4 - 5.

As further depicted in FIG. 2, the example buck switching circuitry 102 includes a controller 218. The controller 218 comprises any circuitry including hardware and/or software configured to generate the switching control signal 226 based on the positive output voltage 108. As depicted in FIG. 2, the controller 218 comprises a feedback terminal (FB) electrically connected to the positive output terminal (e.g., terminal 114, VPOS) configured to measure the positive output voltage 108. In addition, the controller 218 includes a ground signal terminal (VSS) electrically connected to the net point 220, and a drain supply terminal (VDD) configured to receive a drain supply voltage.

In some embodiments, the controller 218 may be configured to adjust the switching control signal 226 according to a duty cycle, wherein the duty cycle is the ratio of the switch on time versus the switching period. Such a control method is also called Pulse Width Modulation (PWM). For example, the controller 218 may be configured to adjust the switching control signal 226 at a 45% duty cycle, meaning the switching control signal 226 is configured to switch the buck switching device 202 on 45% of the switching frequency period. The controller 218 may adjust the duty cycle according to the positive output voltage 108. For example, in an instance in which the positive output voltage 108 moves above the desired output voltage, the controller 218 may reduce the duty cycle, or the buck switching device 202 on time. Conversely, in an instance in which the positive output voltage 108 drops below the desired output voltage, the controller 218 may increase the duty cycle, or the buck switching device 202 on time. The controller 218 may further be configured to control flow through the freewheeling path in a case in which the freewheeling device 210 is replaced by a controlled switch like a MOSFET for example.

As further depicted in FIG. 2, the example buck switching circuitry 102 comprises a voltage source 216 wherein the positive terminal (e.g., first terminal) is electrically connected to the drain terminal of the buck switching device 202 and the negative terminal (e.g., second terminal) is electrically connected to the net point 220. The voltage source 216 may comprise any direct current (DC) voltage source configured to generate a high voltage potential 224. A high voltage potential 224 is any electrical signal comprising a voltage having an amplitude higher than the amplitude of the desired positive output voltage 108. In some embodiments, the voltage source 216 may be a DC voltage source. For example, the voltage source 216 may comprise a 30 volt direct current voltage source 216 with a desired positive output voltage 108 of +12 volts.

In some embodiments, the high voltage potential 224 may be derived from an alternating current voltage source. In one such example, the high voltage potential 224 may be derived from a 230 volt root mean square alternating current voltage source with a desired positive output voltage 108 of +12 volts. In such an example, the DC voltage comprising the high voltage potential 224 may be generate using a full wave or single-wave rectifier.

As further depicted in FIG. 2, the example buck switching circuitry 102 comprises an energy storage device 204 comprising a first terminal electrically connected to the source terminal of the buck switching device 202 and a second terminal electrically connected to a first terminal of the positive output capacitor 206. The energy storage device 204 may comprise any circuitry or device configured to store energy from a high voltage potential 224 and release and/or generate energy when disconnected from the high voltage potential 224. As depicted in FIG. 2, the energy storage device 204 comprises an inductor. The energy storage device 204 may comprise a coiled conductor configured to store electrical energy in a magnetic field. In addition, the energy storage device 204 may oppose sudden changes in current. For example, in a switch closed state in which the buck switching device 202 closes and the high voltage potential 224 is received, the energy storage device 204 may slow the increase of its current. In a freewheeling state, when the buck switching device 202 opens, the energy storage device 204 utilizes the energy stored in its magnetic field to increase the voltage applied to freewheeling device 210 from a negative to a positive level, enabling this diode to turn on spontaneously and ensuring the continuity of conduction of energy storage device 204 current. This freewheeling current will then circulate through positive output capacitor 206, negative output capacitor 208, and freewheeling device 210, generating the positive out voltage 108 and the negative output voltage 110.

As further depicted in FIG. 2, the example buck switching circuitry 102 comprises a positive output capacitor 206 comprising a first terminal electrically connected to the second terminal electrically of the energy storage device 204, and a second terminal electrically connected to net point 220 which is further electrically connected to ground reference 232. The voltage across the positive output capacitor 206 is the positive output voltage 108.

As further depicted in FIG. 2, the freewheeling circuitry 104 comprises a negative output capacitor 208 and a freewheeling device 210 electrically connected in series.

As depicted in FIG. 2, the negative output capacitor 208 comprises a first terminal electrically connected to the net point 220 which is further electrically connected to ground reference 232; and a second terminal electrically connected to the net point 228 which is further electrically connected to an anode terminal of the freewheeling device 210. The voltage across the negative output capacitor 208 is the negative output voltage 110. The negative output capacitor 208 is charged by the energy released by the energy storage device 204 during the freewheeling mode of the converter circuit 200.

As further depicted in FIG. 2, the freewheeling device 210 comprises an anode terminal electrically connected to the net point 228 which is further electrically connected to the second terminal of the negative output capacitor; and a cathode terminal which is electrically connected to the net point 230 which is further electrically connected to the first terminal of the energy storage device 204. The freewheeling device 210 may comprise any diode device enabling electric current to flow in one direction or could be replaced by a controlled switch like a n-channel MOSFET with a source terminal connected to net point 228 and a drain terminal connected to net point 230, or a p-channel MOSFET with a source terminal connected to net point 230 and a drain terminal connected to net point 228. The freewheeling device 210 is enabled during a freewheeling state of the converter circuit 200. In some embodiments, if the freewheeling device 210 is replaced by a controlled switch, it is enabled and disabled by the controller 218. By enabling the freewheeling device 210 during the freewheeling state, the energy released by the energy storage device 204 charges the negative output capacitor 208, generating the negative output voltage 110 relative to ground reference 232. Current flow in the freewheeling state is further described in relation to FIG. 4.

As further depicted in FIG. 2, the control circuitry 106 comprises as an example embodiment, a hysteresis comparator 214 and a negative output regulation switch 212.

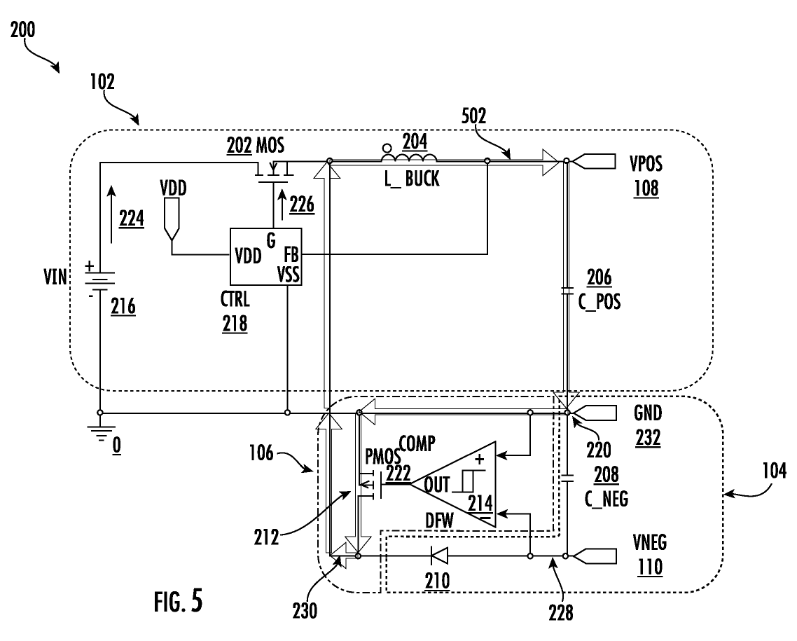

As depicted in FIG. 2, the control circuitry 106 comprises a negative output regulation switch 212. A negative output regulation switch 212 comprises any switching component configured to change between a closed state and an open state based on a received hysteresis control signal 222. As depicted in FIG. 2, the negative output regulation switch 212 comprises a p-channel MOSFET comprising a drain terminal electrically connected to the net point 230 and the cathode terminal of the freewheeling device 210; a gate terminal electrically connected to an output terminal of the hysteresis comparator 214; and a source terminal electrically connected to the net point 220 and the ground reference 232. The negative output regulation switch 212 is electrically connected in parallel to the negative output capacitor 208 and enables current flow through the switch during a freewheeling state in an instance in which the negative output voltage 110 exceeds the negative output voltage reference, for example, as further described in relation to FIG. 5. In this way, the negative output regulation switch 212 may be used to limit the charge of the negative output capacitor 208 and in this way the maximum level of the negative output voltage 110.

As depicted in FIG. 2, the hysteresis comparator 214 comprises a first terminal electrically connected to the net point 220 which is further electrically connected to ground reference 232; and a second terminal electrically connected to net point 228 which is further electrically connected to the negative output terminal (VNEG). Thus, the hysteresis comparator 214 may be configured to compare the negative output voltage 110 to a negative output voltage reference. The hysteresis comparator 214 is further configured to generate a hysteresis control signal 222 (e.g., control signal) based on the comparison of the negative output voltage 110 and the negative output voltage reference. For example, in an instance in which the negative output voltage 110 exceeds the negative output voltage reference, the hysteresis comparator 214 may update the hysteresis control signal 222 to enable the embedded negative output regulation switch 212, for example, by setting the hysteresis control signal 222 to a negative voltage by reference to the ground reference 232. Conversely, in an instance in which the amplitude of the negative output voltage 110 drops below the amplitude of the negative output voltage reference by a value difference defined as the hysteresis threshold, or sometimes call hysteresis band or hysteresis lag, the hysteresis comparator 214 may update the hysteresis control signal 222 to disable the embedded negative output regulation switch 212, for example, by setting the hysteresis control signal 222 to 0 volt, still to reference to ground reference 232.

Referring now to FIG. 3, current flow 302 through the example converter circuit 200 in a switch closed state is depicted. The switch closed state may be enabled by closing the buck switching device 202 based on the switching control signal 226 generated by the controller 218. As depicted in FIG. 3, in an instance in which the buck switching device 202 is closed, current flow 302 originates from the generation of a high voltage potential 224 at the positive terminal of the voltage source 216. The current flow 302 passes through the buck switching device 202 and the energy storage device 204 to charge the positive output capacitor 206. Current flow 302 continues through net point 220 and returns to the negative terminal of the voltage source 216. The current flow 302 utilizes the energy generated by the voltage source 216 to charge the positive output capacitor 206 and generate the positive output voltage 108.

Referring now to FIG. 4, current flow 402 through the example converter circuit 200 in a freewheeling state is depicted. The freewheeling state may be enabled by opening the buck switching device 202 based on the switching control signal 226 generated by the controller 218. As depicted in FIG. 4, in an instance in which the buck switching device 202 is open, current flow 402 originates from the energy storage device 204. Thus, the current flow 402 passes through and charges the positive output capacitor 206. Current flow 402 continues through net point 220 and further passes through and charges and returns the negative output capacitor 208. Current flow 402 continues through the freewheeling device 210 and through net point 230 back to the first terminal of the energy storage device 204.

The current flow 402 utilizes the energy stored in the energy storage device 204 to charge the positive output capacitor 206 and the negative output capacitor 208, generating both the positive output voltage 108 and the negative output voltage 110.

Referring now to FIG. 5, current flow 502 is depicted, illustrating the flow of current through the example converter circuit 200 in an instance in which the converter circuit 200 is in a freewheeling state and the negative output regulation switch 212 is enabled. The negative output regulation switch 212 may be enabled to regulate the voltage across the negative output capacitor 208. For example, in an instance in which the negative output voltage 110 exceeds a negative output voltage reference. The negative output regulation switch 212 is enabled based on a hysteresis control signal 222 generated by a hysteresis comparator 214. Enabling the negative output regulation switch 212 enables the current flow 502 to bypass the negative output capacitor 208 and pass through the negative output regulation switch 212, thus reducing the charge build up at the negative output capacitor 208 and the negative output voltage 110.

As depicted in FIG. 5, the current flow 502 originates from the energy storage device 204. The current flow 502 passes through and charges the positive output capacitor 206. Current flow 502 continues through net point 220. Instead of charging and passing through the negative output capacitor 208, current flow continues through the negative output regulation switch 212. Further, current flow 502 passes through the net point 230 and back to the first terminal of the energy storage device 204.

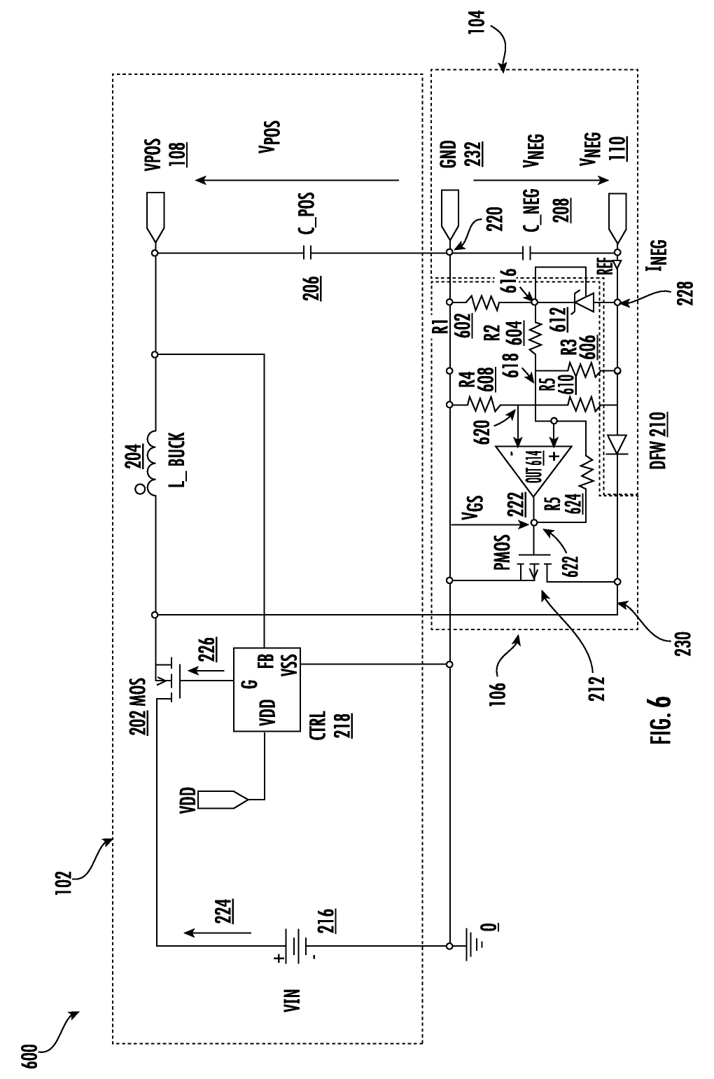

Referring now to FIG. 6, an example converter circuit 600 is provided. The converter circuit 600 is one example embodiment of the converter circuit 100. It will be appreciated that various embodiments may include more or less circuitries than depicted in FIG. 6.

As depicted in FIG. 6, the converter circuit 600 comprises a buck switching device 202 comprising a drain terminal electrically connected to a positive terminal of a voltage source 216; a gate terminal electrically connected to a gate output terminal of a controller 218, and a source terminal electrically connected to a first terminal of an energy storage device 204. The conductive path between the source terminal of the buck switching device 202 and the first terminal of the energy storage device 204 is further electrically connected to net point 230. The buck switching device 202 is configured to receive a high voltage potential 224 from the voltage source 216 and a switching control signal 226 from the controller 218.

As further depicted in FIG. 6, the controller 218 comprises a feedback terminal (FB) electrically connected to the positive output terminal (e.g., terminal 114, VPOS) of the converter circuit 600 and is configured to measure the positive output voltage 108. In addition, the controller 218 includes a ground signal terminal (VSS) electrically connected to the net point 220, and a drain supply terminal (VDD) configured to receive a drain supply voltage.

As further depicted in FIG. 6, the example converter circuit 600 comprises a voltage source 216 wherein a positive terminal of the voltage source 216 is electrically connected to the drain terminal of the buck switching device 202 and the negative terminal of the voltage source 216 is electrically connected to the net point 220.

As further depicted in FIG. 6, the converter circuit 600 comprises an energy storage device 204 comprising a first terminal electrically connected to the source terminal of the buck switching device 202 and a second terminal electrically connected to a first terminal of the positive output capacitor 206.

As further depicted in FIG. 6, the example converter circuit 600 comprises a positive output capacitor 206 comprising a first terminal electrically connected to the second terminal electrically of the energy storage device 204, and a second terminal electrically connected to net point 220 which is further electrically connected to ground reference 232. The voltage across the positive output capacitor 206 is output as the positive output voltage 108.

As further depicted in FIG. 6, the converter circuit 600 comprises a negative output capacitor 208. The negative output capacitor 208 comprises a first terminal electrically connected to the net point 220 which is further electrically connected to ground reference 232; and a second terminal electrically connected to the net point 228 which is further electrically connected to an anode terminal of the freewheeling device 210. The voltage across the negative output capacitor 208 is output as the negative output voltage 110.

As further depicted in FIG. 6, the freewheeling device 210 comprises an anode terminal electrically connected to the net point 228 which is further electrically connected to the second terminal of the negative output capacitor; and a cathode terminal which is electrically connected to the net point 230 which is further electrically connected to the first terminal of the energy storage device 204.

As further depicted in FIG. 6, the example converter circuit 600 comprises an example embodiment of control circuitry 106. The control circuitry 106 of FIG. 6 is one example embodiment of control circuitry 106. It will be appreciated that various embodiments may include more or less circuitries than depicted in FIG. 6.

As depicted in FIG. 6, the example control circuitry 106 comprises an adjustable shunt voltage reference device 612 comprising an anode terminal electrically connected to the net point 228 and further electrically connected to the negative output terminal (VNEG); a cathode terminal electrically connected to a net point 616; and a reference terminal electrically connected to the net point 616.

The example control circuitry 106 further includes a first resistor 602 comprising a first terminal electrically connected to the net point 220 and a second terminal electrically connected to the net point 616.

The example control circuitry 106 further includes a second resistor 604 comprising a first terminal electrically connected to the net point 616 and a second terminal electrically connected to the net point 618, which is further electrically connected to the non-inverting input terminal of a comparator 614.

The example control circuitry 106 further includes a third resistor 606 comprising a first terminal electrically connected to the net point 228 and a second terminal electrically connected to the net point 618, which is further electrically connected to the non-inverting input terminal of the comparator 614.

The example control circuitry 106 further includes a fourth resistor 608 comprising a first terminal electrically connected to the net point 220 and a second terminal electrically connected to the net point 620, which is further electrically connected to the inverting input terminal of the comparator 614.

The example control circuitry 106 further includes a fifth resistor 610 comprising a first terminal electrically connected to the net point 228 and a second terminal electrically connected to the net point 620, which is further electrically connected to the inverting output of the comparator 614.

The example control circuitry 106 further includes a comparator 614 comprising an inverting input terminal electrically connected to the net point 620 and a non-inverting input terminal electrically connected to the net point 618.

The example control circuitry 106 further includes a sixth resistor 624 comprising a first terminal electrically connected to the output terminal of the comparator 614 and a second terminal electrically connected to the net point 618, which is further electrically connected to the non-inverting input terminal of the comparator 614.

As depicted in FIG. 6, the control circuitry 106 is configured to compare the voltage at net point 620, representative of the negative output voltage 110, with the voltage at net point 618, representative of the negative output voltage reference as known by those skilled in the art. In an instance in which the negative output voltage 110 exceeds the negative output voltage reference, the comparator 614 may generate the hysteresis control signal 222 such that the negative output regulation switch 212 is enabled, for example, by setting the hysteresis control signal 222 to a low level or negative voltage. Conversely, in an instance in which the amplitude of the negative output voltage 110 drops below the amplitude of the negative output voltage reference, the comparator 614 may generate the hysteresis control signal 222 such that the negative output regulation switch 212 is disabled, for example, by setting the hysteresis control signal 222 to a high level.

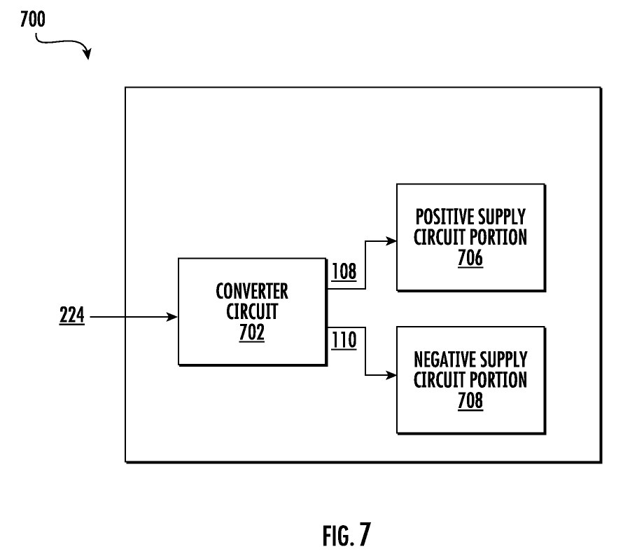

Referring now to FIG. 7, a block diagram of an example electrical system 700 is provided. As depicted in FIG. 7, the example electrical system 700 includes converter circuit 702 configured to receive a high voltage potential 224 from a high voltage source. As further depicted in FIG. 7, the converter circuit 702 is configured to generate a positive output voltage 108 and a negative output voltage 110, wherein the positive output voltage 108 is transmitted to one or more circuits operating with a positive voltage referenced to the electrical ground reference 232 and wherein the negative output voltage 110 is transmitted to one or more circuit portions 708 embedding devices that may need a negative voltage bias, referenced to the GND, to ensure or improve their operation.

As depicted in FIG. 7, the electrical system 700 comprises one or more circuit portions 706 supplied with positive voltage. A circuit portion 706 supplied with positive voltage comprises any circuitry including hardware and/or software configured to receive a positive supply voltage. In some embodiments, a circuit portion 706 supplied with positive voltage may require a supply voltage less than the high voltage potential 224 generated by the voltage source 216. In such an instance, the converter circuit 702 may generate a positive output voltage 108 comprising a voltage amplitude less than the high voltage potential 224 amplitude and within the specifications of the circuit portion 706 supplied with positive voltage. Example circuit portions 706 supplied with positive voltage may include silicon MOSFETs, power factor correction (PFC) circuits, intelligent power module (IPM) circuit, or other electrical components.

As depicted in FIG. 7, the electrical system 700 further comprises one or more circuit portions 708 supplied with negative voltage. A circuit portion 708 supplied with negative voltage comprises any circuitry including hardware and/or software configured to receive a negative supply voltage. In some embodiments, a circuit portion 708 supplied with negative voltage may require a supply voltage with an amplitude usually lower than the amplitude of the high voltage potential 224 generated by the voltage source 216. In such an instance, the converter circuit 702 may generate a negative output voltage 110 comprising a voltage amplitude usually lower, but not only, than the high voltage potential 224 amplitude and within the specifications of the circuit portion 708 supplied with negative voltage. Example circuit portions 708 supplied with negative voltage may include Silicon Carbide metal-oxide-semiconductor field-effect transistors (MOSFETs), Gallium Nitride MOSFETs, triacs (triodes for alternating current), and/or other electrical components.

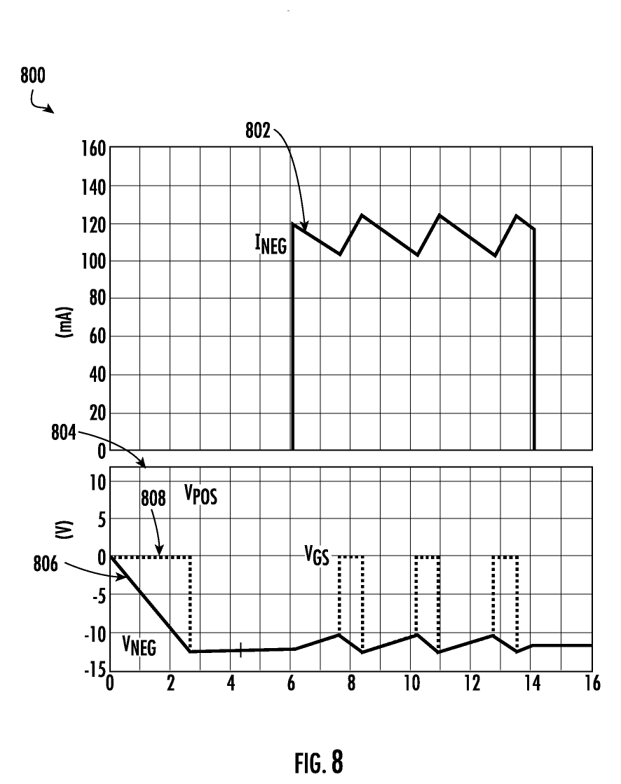

Referring now to FIG. 8, an example signal diagram 800 is provided. FIG. 8 depicts a signal diagram 800 for a converter circuit configured to generate a +12 volts positive output voltage and a negative output voltage around 10 to 14 volts.

As depicted in FIG. 8, the positive output voltage 108 is kept constant due to the switching on and off of the buck switching device continuously entering into a switch closed state and a freewheeling state.

As further depicted in FIG. 8, the negative output voltage 110 is charged by the energy storage device of the converter circuit during the free wheeling state. Thus, the negative output voltage 110 across a negative capacitor increases over time.

As further depicted in FIG. 8, the hysteresis control signal is given by signal 808 which actually equals to hysteresis control signal 222 referenced to net point 230. Signal 808 controls the negative output regulation switch based on a comparison of the negative output voltage to a negative output voltage reference. In an instance in which the negative output voltage 110 exceeds the negative output voltage reference, the hysteresis control signal 222 is brought to a negative voltage enabling the PMOS negative output regulation switch. With the negative output regulation switch enabled, the negative output voltage remains constant.

As further depicted in FIG. 8, the negative supply device current 802 represents the current pulled by a negative supply device configured to receive the negative output voltage 110. Thus, as the negative supply device current 802 increases, the negative output voltage 110 decreases. The negative output voltage 110 decreases until the hysteresis control signal 222 is updated based on a comparison of the negative output voltage 110 to the negative output voltage reference. As depicted in FIG. 8, the hysteresis control signal 222 is set to 0 volt, disabling the negative output regulation switch until the negative output voltage 110 once again exceeds the negative output voltage reference. The process continues to maintain a consistent and reliable negative output voltage 110.

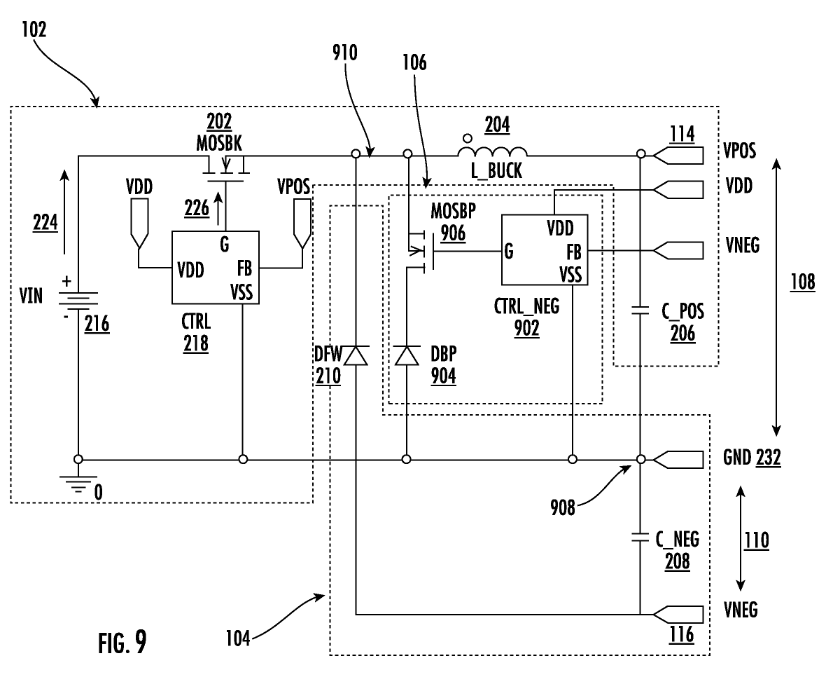

Referring now to FIG. 9, an example converter circuit 900 is provided. The converter circuit 900 is one example embodiment of the converter circuit 100. It will be appreciated that various embodiments may include more or less circuitries than depicted in FIG. 9. The example converter circuit 900 includes buck switching circuitry 102 electrically connected to freewheeling circuitry 104, and further electrically connected to control circuitry 106.

As depicted in FIG. 9, the buck switching circuitry 102 comprises a voltage source 216, a controller 218, a buck switching device 202, an energy storage device 204, and a positive output capacitor 206. As further depicted in FIG. 9, the buck switching circuitry 102 is configured to generate a positive output voltage 108 applied across terminal 114 and ground reference 232 (e.g., across the positive output capacitor 206). As described herein, the positive output voltage 108, refers to the potential difference between the terminal 114 and the ground reference 232.

As depicted in FIG. 9, the buck switching device 202 comprises an n-type MOSFET comprising a drain terminal electrically connected to a positive terminal of the voltage source 216, a gate terminal electrically connected to a gate output terminal of the controller 218, and a source terminal electrically connected to a net point 910. In an instance in which the buck switching device 202 is enabled through the switching control signal 226, the converter circuit 200 operates in a closed switch state. During the closed switch state, the high voltage potential 224 is used to charge the energy storage device 204 with a current which in addition, generates the positive output voltage 108 across the positive output capacitor 206.

In an instance in which the buck switching device 202 is disabled through the switching control signal 226, the converter circuit 200 operates in an open switch state, also known as a freewheeling state. During the freewheeling state, the buck switching device 202 is open. Thus, the positive output voltage 108 is generated across the positive output capacitor 206 based on the energy stored in the energy storage device 204. In addition, the negative output voltage 110 is generated across the negative output capacitor 208 based on the energy stored in the energy storage device 204 during the freewheeling state.

As further depicted in FIG. 9, the example buck switching circuitry 102 includes a controller 218. As depicted in FIG. 9, the controller 218 comprises a feedback terminal (FB) electrically connected to the positive output terminal (e.g., terminal 114) configured to measure the positive output voltage 108. In addition, the controller 218 includes a ground signal terminal (VSS) electrically connected to the net point 908, and a drain supply terminal (VDD) configured to receive a drain supply voltage.

In some embodiments, the controller 218 may be configured to adjust the switching control signal 226 according to a duty cycle, wherein the duty cycle is the ratio of the switch on time versus the switching period. Such a control method is also called Pulse Width Modulation (PWM).

As further depicted in FIG. 9, the example buck switching circuitry 102 comprises a voltage source 216 wherein the positive terminal is electrically connected to the drain terminal of the buck switching device 202 and the negative terminal is electrically connected to the net point 908.

As further depicted in FIG. 9, the example buck switching circuitry 102 comprises an energy storage device 204 comprising a first terminal electrically connected to the source terminal of the buck switching device 202 and a second terminal electrically connected to a first terminal of the positive output capacitor 206. In a switch closed state in which the buck switching device 202 closes and the high voltage potential 224 is received, the energy storage device 204 may slow the increase of its current. In a freewheeling state, when the buck switching device 202 opens, the energy storage device 204 utilizes the energy stored in its magnetic field to increase the voltage applied to freewheeling device 210 from a negative to a positive level, enabling this diode to turn on spontaneously and ensuring the continuity of conduction of energy storage device 204 current. This freewheeling current will then circulate through positive output capacitor 206, negative output capacitor 208, and freewheeling device 210, generating the positive out voltage 108 and the negative output voltage 110.

As further depicted in FIG. 9, the example buck switching circuitry 102 comprises a positive output capacitor 206 comprising a first terminal electrically connected to the second terminal electrically of the energy storage device 204, and a second terminal electrically connected to net point 220 which is further electrically connected to ground reference 232. The voltage across the positive output capacitor 206 is the positive output voltage 108.

As further depicted in FIG. 9, the freewheeling circuitry 104 comprises a negative output capacitor 208 and a freewheeling device 210 electrically connected in series.

As depicted in FIG. 9, the negative output capacitor 208 comprises a first terminal electrically connected to the net point 908 which is further electrically connected to ground reference 232; and a second terminal electrically connected to an anode terminal of the freewheeling device 210. The voltage across the negative output capacitor 208 is the negative output voltage 110. The negative output capacitor 208 is charged by the energy released by the energy storage device 204 during the freewheeling mode of the converter circuit 200.

As further depicted in FIG. 9, the freewheeling device 210 comprises an anode terminal electrically connected to the second terminal of the negative output capacitor; and a cathode terminal which is electrically connected to the net point 910 which is further electrically connected to the first terminal of the energy storage device 204.

As further depicted in FIG. 9, the control circuitry 106 comprises as an example embodiment a negative controller 902, a control circuit diode 904, and a negative output regulation switch 906.

As depicted in FIG. 9, the control circuitry 106 comprises a negative output regulation switch 906. The negative output regulation switch 906 comprises an n-channel MOSFET. The source terminal of the negative output regulation switch 906 is electrically connected to a cathode terminal of a control circuitry diode 904; the gate terminal of the negative output regulation switch 906 is electrically connected to a gate terminal of the negative controller 902; the drain terminal of the negative controller 902 is electrically connected to the net point 910 which is further electrically connected to the first terminal of the energy storage device 204. The negative output regulation switch 906 ensures a current path through the positive output capacitor 206 and the freewheeling device 210 in an instance in which the negative output capacitor 208 is sufficiently charged (e.g., the negative output voltage 110 exceeds a negative output voltage reference).

As further depicted in FIG. 9, the control circuitry 106 comprises a control circuit diode 904 (DBP). The control circuit diode comprises an anode terminal electrically connected to the net point 908, and a cathode terminal electrically connected to the source terminal of the buck switching device 202. The control circuit diode 904 is connected in series with the negative output regulation switch 906 to avoid reverse current conduction through the negative output regulation switch 906 body diode in an instance in which the buck switching device 202 is switched on.

As further depicted in FIG. 9, the control circuitry 106 comprises a negative controller 902. The negative controller 902 comprises a feedback terminal (FB) electrically connected to the negative output terminal (e.g., terminal 116) configured to measure the negative output voltage 110. In addition, the controller 902 includes a ground signal terminal (VSS) electrically connected to the net point 908, and a negative output terminal (VDD) configured to receive the negative output voltage 110.The negative output regulation switch 906 of the example converter circuit 900 is referenced to the same potential as the buck switching device 202. Both the negative output regulation switch 906 and the buck switching device 202 may be easily controlled from the same control circuit. For example, in some embodiments, the controller 218, and negative controller 902 may be integrated in a single chip.

### Exemplary Methods

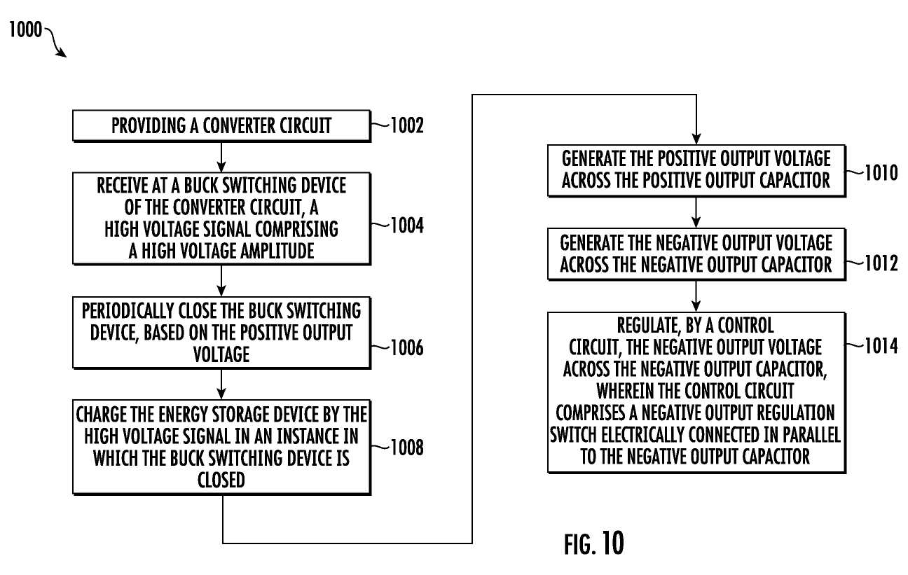

Referring now to FIG. 10, an example process 1000 for generating a positive output voltage (e.g., positive output voltage 108) and a negative output voltage (e.g., negative output voltage 110) based on a high voltage signal (e.g., high voltage potential 224) received at a converter circuit (e.g. converter circuit 100, 200, 600,702) is provided. At block 1002, the converter circuit is provided, the converter circuit comprising buck switching circuitry (e.g., buck switching circuitry 102) and freewheeling circuitry (e.g., freewheeling circuitry 104). The buck switching circuitry comprising a buck switching device (e.g., buck switching device 202), an energy storage device (e.g., energy storage device 204), and a positive output capacitor (e.g., positive output capacitor 206). The freewheeling circuitry comprising a negative output capacitor (e.g., negative output capacitor 208), and a freewheeling diode (e.g., freewheeling device 210). As described herein, the buck switching device, the energy storage device, the positive output capacitor, the negative output capacitor, and the freewheeling device are electrically connected in series.

At block 1004, the converter circuit receives at the buck switching device of the converter circuit, the high voltage signal comprising a high voltage amplitude. In some embodiments, the positive output voltage and the negative output voltage generated by the converter circuit may each comprise a voltage amplitude that is less than the voltage amplitude of the high voltage signal.

At block 1006, the converter circuit periodically closes the buck switching device, based on the positive output voltage. The converter circuit may comprise a controller (e.g., controller 218) configured to measure the positive output voltage and adjust the duty cycle of the buck switching device based on the positive output voltage such that the positive output voltage remains constant.

At block 1008, the converter circuit charges the energy storage device by the high voltage signal in an instance in which the buck switching device is closed. During a closed switch state in which the buck switching device is closed, the converter circuit utilizes the energy of the high voltage signal to charge the energy storage device.

At block 1010, the converter circuit generates the positive output voltage across the positive output capacitor. In an instance in which the buck switching device is closed, the positive output voltage across the positive output capacitor is generated by the high voltage signal. In an instance in which the buck switching device is open, and the converter circuit is in a freewheeling state, the positive output voltage across the positive output capacitor is maintained by the energy released by the energy storage device.

At block 1012, the converter circuit generates the negative output voltage across the negative output capacitor. The negative output voltage across the negative output capacitor may be generated during the freewheeling state of the converter circuit. By opening the buck switching device and allowing current to flow through the negative output capacitor and freewheeling device, the negative output voltage across the negative output capacitor is generated by the energy storage device.

At block 1014, the converter circuit regulates, by a hysteresis control circuit (e.g., control circuitry 106), the negative output voltage across the negative output capacitor, wherein the hysteresis control circuit comprises a negative output regulation switch electrically connected in parallel to the negative output capacitor. As described herein, the control circuitry may generate, at a hysteresis comparator (e.g., hysteresis comparator 214), a hysteresis control signal (e.g., hysteresis control signal 222) based on a comparison of the negative output voltage to a negative output voltage reference. The hysteresis control signal may enable the negative output regulation switch in an instance in which the negative output voltage exceeds the negative output voltage reference. By positioning the negative output regulation switch in parallel with the negative output capacitor, enabling the negative output regulation switch may prevent the negative output voltage from increasing. Disabling the negative output regulation switch may allow the negative output voltage to further increase.

### Conclusion

While this detailed description has set forth some embodiments of the present invention, the appended claims cover other embodiments of the present invention which differ from the described embodiments according to various modifications and improvements. For example, one skilled in the art may recognize that such principles may be applied to any electronic device that utilizes positive supply devices and negative supply devices requiring supply voltages different from an input supply voltage, for example, home appliances, computer, Lighting, Air-Conditioning, Server, Telecom, Computer/Consumer, charger, Energy storage, UPS, charging pile, Power Conversion System, industrial control systems, and other applications connected to 1-phase or 3-phase AC or DC grid or powered by batteries.

Within the appended claims, unless the specific term “means for” or “step for” is used within a given claim, it is not intended that the claim be interpreted under 35 U.S.C. 112, paragraph 6.

Use of broader terms such as “comprises,” “includes,” and “having” should be understood to provide support for narrower terms such as “consisting of,” “consisting essentially of,” and “comprised substantially of” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

1. A converter circuit comprising:
a first terminal and a second terminal configured to receive a DC voltage;
buck switching circuitry comprising:
a buck switching device;
an energy storage device; and
a positive output capacitor; and
freewheeling circuitry comprising:
a negative output capacitor; and
a freewheeling device;
wherein the buck switching device, the energy storage device, the positive output capacitor, the negative output capacitor, and the freewheeling device are electrically connected in series;
wherein a positive output voltage relative to a common ground terminal is generated across the positive output capacitor, and wherein a negative output voltage relative to the common ground terminal is generated across the negative output capacitor, and
wherein the common ground terminal is the second terminal.

2. The converter circuit of claim 1 further comprising:
a control circuitry comprising:
a negative output regulation switch electrically connected in parallel to the negative output capacitor and the freewheeling device;
wherein the negative output regulation switch regulates the negative output voltage across the negative output capacitor.

3. The converter circuit of claim 2, wherein to regulate the negative output voltage across the negative output capacitor, the control circuitry is achieving a Hysteresis control law configured to enable or disable the negative output regulation switch in accordance with the Hysteresis control law.

4. The converter circuit of claim 2, wherein to regulate the negative output voltage across the negative output capacitor, the control circuit updates a duty cycle associated with the negative output regulation switch.

5. The converter circuit of claim 2, wherein the negative output regulation switch comprises:
a first p-channel metal-oxide-semiconductor (PMOS) comprising:
a first PMOS source terminal electrically connected to a net point between the positive output capacitor and the negative output capacitor;
a first PMOS drain terminal electrically connected to an output terminal of the freewheeling device; and
a first PMOS gate terminal configured to receive a control signal from the control circuitry.

6. The converter circuit of claim 2, wherein the negative output regulation switch comprises:
a first n-channel metal-oxide-semiconductor (NMOS) comprising:
a first NMOS source terminal electrically connected to a net point between the buck switching device and the energy storage device;
a first NMOS drain terminal electrically connected to the cathode of a second diode; and
a first NMOS gate terminal configured to receive a control signal from the control circuitry;
wherein an anode terminal of the second diode is electrically connected to the common ground terminal.

7. The converter circuit of claim 1, wherein the freewheeling device is a diode.

8. The converter circuit of claim 1, wherein the freewheeling device is a second p-channel metal-oxide-semiconductor (PMOS) or a first n-channel metal-oxide-semiconductor (NMOS).

9. An electrical system comprising:
a converter circuit comprising:
a first terminal and a second terminal configured to receive a DC voltage;
buck switching circuitry comprising:
a buck switching device;
an energy storage device; and
a positive output capacitor; and
freewheeling circuitry comprising:
a negative output capacitor; and
a freewheeling device;
wherein the buck switching device, the energy storage device, the positive output capacitor, the negative output capacitor, and the freewheeling device are electrically connected in series;
wherein a positive output voltage relative to a common ground terminal is generated across the positive output capacitor, and wherein a negative output voltage relative to the common ground terminal is generated across the negative output capacitor, and
wherein the common ground terminal is the second terminal; and
a positive circuit portion supplied with positive voltage configured to receive the positive output voltage from the converter circuit; and
a negative circuit portion supplied with negative voltage configured to receive the negative output voltage from the converter circuit.

10. The electrical system of claim 9, wherein the converter circuit further comprises:
a control circuitry comprising:
a negative output regulation switch electrically connected in parallel to the negative output capacitor and the freewheeling device;
wherein the negative output regulation switch regulates the negative output voltage across the negative output capacitor.

11. The electrical system of claim 10, wherein to regulate the negative output voltage across the negative output capacitor, the control circuitry is achieving a Hysteresis control law configured to enable and disable the negative output regulation switch in accordance with the Hysteresis control law.

12. The electrical system of claim 10, wherein to regulate the negative output voltage across the negative output capacitor, the control circuit updates a duty cycle associated with the negative output regulation switch.

13. The electrical system of claim 10, wherein the negative output regulation switch of the control circuitry comprises:
a first p-channel metal-oxide-semiconductor (PMOS) comprising:
a first PMOS source terminal electrically connected to a net point between the positive output capacitor and the negative output capacitor;
a first PMOS drain terminal electrically connected to an output terminal of the freewheeling device; and
a first PMOS gate terminal configured to receive a control signal from the control circuitry.

14. The electrical system of claim 10, wherein the negative output regulation switch comprises:
a first n-channel metal-oxide-semiconductor (NMOS) comprising:
a first NMOS source terminal electrically connected to a net point between the buck switching device and the energy storage device;
a first NMOS drain terminal electrically connected to the cathode of a second diode; and
a first NMOS gate terminal configured to receive a control signal from the control circuitry; and the second diode comprising an anode terminal connected to the common ground terminal.

15. The electrical system of claim 14, wherein the freewheeling device is a diode.

16. A method for generating a positive output voltage relative to a common ground terminal and a negative output voltage relative to the common ground terminal based on a high voltage signal at a converter circuit, the method comprising:
providing the converter circuit comprising:
a first terminal and a second terminal configured to receive a DC voltage, wherein the common ground terminal is the second terminal;
buck switching circuitry comprising:
a buck switching device;
an energy storage device; and
a positive output capacitor; and
freewheeling circuitry comprising:
a negative output capacitor; and
a freewheeling device;
wherein the buck switching device, the energy storage device, the positive output capacitor, the negative output capacitor, and the freewheeling device are electrically connected in series;
receiving at the buck switching device of the converter circuit, the high voltage signal comprising a high voltage amplitude;
periodically closing the buck switching device, based on the positive output voltage;
generating the positive output voltage across the positive output capacitor; and
generating the negative output voltage across the negative output capacitor.

17. The method of claim 16, further comprising:
regulating, by a control circuitry, the negative output voltage across the negative output capacitor, wherein the control circuitry comprises a negative output regulation switch electrically connected in parallel to the negative output capacitor.

18. The method of claim 17, wherein regulating the negative output voltage across the negative output capacitor further comprises:
generating, at a hysteresis comparator, a control signal based on a comparison of the negative output voltage to a negative output voltage reference; and
enabling the negative output regulation switch to regulate the negative output voltage.

19. The method of claim 18, wherein the negative output regulation switch comprises:
a first p-channel metal-oxide-semiconductor (PMOS) comprising:
a first PMOS source terminal electrically connected to a net point between the positive output capacitor and the negative output capacitor;
a first PMOS drain terminal electrically connected to an output terminal of the freewheeling device; and
a first PMOS gate terminal configured to receive the control signal from the hysteresis comparator.

20. The method of claim 18, wherein the negative output regulation switch comprises:
a first n-channel metal-oxide-semiconductor (NMOS) comprising:
a first NMOS source terminal electrically connected to a net point between the buck switching device and the energy storage device;
a first NMOS drain terminal electrically connected to the cathode of a second diode; and
a first NMOS gate terminal configured to receive a control signal from the control circuitry;
wherein an anode terminal of the second diode is electrically connected to the common ground terminal.
